(19) United States
(12) Patent Application Publication
(10) Pub. No.: US 2001/0011287 A1
(43) Pub. Date: Aug. 2, 2001

(54) APPARATUS FOR DEFINING A STYLE SPECIFICATION FOR VISUALLY OUTPUTTING A STRUCTURED DOCUMENT

(76) Inventors: MASATOMO GOTO, HYOGO (JP); TOSHIMITSU SUZUKI, AKASHI-SHI (JP); KAZUNI SAITO, AKASHI-SHI (JP); SADAO YASHIRO, AKASHI-SHI (JP); TAKAHIDE MURAMOTO, AKASHI-SHI (JP)

Correspondence Address: STAAS & HALSEY LLP, 700 11TH STREET, NW, SUITE 500, WASHINGTON, DC, 20001, US

(21) Appl. No.: 09/094,607

(22) Filed: Jun. 15, 1998

(30) Foreign Application Priority Data
Nov. 11, 1997 (JP) 9-308148

(51) Int. Cl. G06F 17/00

(52) U.S. Cl. 707/513

(57) ABSTRACT

In an apparatus defining a style specification for visually outputting a structured document, a group of samples which have been confirmed as having no errors in the notation are registered in regard to the specification information required for style specification. The group of samples is presented to a user when the user defines the style. The user is then capable of selecting a sample corresponding to the desired element forming the document from the group of samples, and is also capable of using it directly. Alternatively, the style specification of each element is generated only by correcting the content to the desired content and a style sheet of the object document can be generated automatically from the generated style specification group.

### CROSS-REFERENCE TO RELATED APPLICATIONS

This application is based on, and claims priority to, Japanese Patent application 9-308148, filed Nov. 11, 1997 in Japan, and which is incorporated herein by reference.

### BACKGROUND OF THE INVENTION

1. Technical Field of the Invention

The present invention relates to an apparatus, method and recording medium of defining the style and format of a document, and in particular, to an apparatus, method and recording medium of easily generating a style and format of a document, having a predetermined kind of elements, based on specifications defined in relation to the document.

2. Description of the Related Art

With the wide spread use of word processors and computer systems, electronic information is now being shared, distributed and recycled among different processors and platforms for information processing. In an effort to promote the use of this versatile electronic information, standards such as Standard Generalized Markup Language (SGML) have been established as the international standards (ISO 8879) defining the frame for structuring information.

SGML is based on the concept that the structure and content (element) of an electronic document are considered separately from the style of the information in the document. That is, the information about the structure and content, are a distinct and different feature from the information related to style, for example representing how to present the content to a user by displaying or printing the document. Hence, the style of the information in the document is defined wholly separate from the structure and content. The information about the content is, however, formatted in conjunction with the style information. Accordingly, documents with the same content can be formatted differently by individually defining the style of the document, or selecting the specifications of the document from among a number of specifications set by a user.

For example, assume a document has a structure formed of a predetermined kind of elements and is to be either displayed or printed. The document is first disassembled into respective elements based on its structure, and predefined information about each element is extracted. The document is then checked to confirm the information is correct. The extracted information, defining the style of each element (style specification), is then aggregated, forming a style sheet. Typically, the style specification in the style sheet is defined using complex functions and notations. Hence, each user is required to learn the functions and notations of the particular style specification in order to define the style sheet, and to understand the knowledge about the style specification.

Therefore, it is a problem in the prior art to reduce the workload of a user by removing the burden on the user to have to understand the style information associated with the style sheet when displaying or printing the document.

It is another problem in the prior art to reduce the processing time for generation of the style sheet when confirming whether or not the style specification, and notations of the style sheet are described accurately.

It is still another problem of the prior art to make it easier for the user to change the style of the document for display or printing to a another style.

It is yet another problem of the prior art to implement defining a style sheet easily and effectively such that an ordinary user can easily implement the specification and change of style of the structured documents.

### SUMMARY OF THE INVENTION

The present invention includes a database which stores sample information required for document style specification. When a user generates the style specification information, the sample information is presented and correction is made to the style specification, if necessary. Hence, a user can easily define a style sheet for displaying or printing a document having a predetermined structure, even without a full understanding of the notation to define the style.

It is an object of the present invention to reduce the workload of a user by removing the burden on the user to have to understand how to write the style information associated with the style sheet when displaying or printing the document.

It is another object of the present invention to reduce the processing time for generation of the style sheet when confirming whether or not the style specification, and notations of the style sheet are described accurately.

It is still another object of the present invention to make it easier for the user to change the style of the document for display or printing to a another style.

It is yet another object of the present invention to implement defining a style sheet easily and effectively such that an ordinary user can easily implement the specification and change of style of the structured documents.

In one embodiment of the present invention, an apparatus defining a structured document system independently administers the structured document. The apparatus includes, for example, a style specification instructing unit instructing generation of the style specification, a style specification generating unit generating a style specification based on the instruction from the style specification instructing unit, and a sample database storing a sample defining the style information and confirming validity of the style information contents. The style specification instructing unit indicates a list of samples registered in the sample database to a user based on the elements of the structured information, causing the user to select a sample to be used to generate the style specification and to issue an instruction to change the contents of the sample, if necessary. The style specification generating unit obtains, from the sample database, contents of the sample selected by the style specification instructing unit for each element and generates the style specification for each element corresponding to the instructed contents to be changed.

In another embodiment of the present invention, a method defines a style specification for visually outputting a structured document. The method includes storing a plurality of sample formats defining various style specifications in a style database, visually displaying the sample formats on a display screen at the instruction of an operator, selecting one sample format from the plurality of sample formats for each element of the structured document, and modifying specification items in the selected sample format and defining style specification.

In yet another embodiment of the present invention, a recording medium recording a computer readable program defines a style specification for visually outputting a structured document. The program includes storing a plurality of sample formats defining various style specifications in a style database, visually displaying the sample formats on a display screen at the instruction of an operator, selecting one sample format from the plurality of sample formats for each element of the structured document, and modifying specification items in the selected sample format and defining style specification.

In still another embodiment of the invention, an apparatus defines a style sheet for outputting a structured document. The apparatus includes, for example, a style specification instructing unit specifying the style specification for the structured document, a style specification generating unit generating a style sheet based on the style specifications specified by the style specification instructing unit, and a sample database storing a sample specification specifying the style specification.

In one aspect of the invention, the sample database includes a macro database storing functions and macros used for style specification, a default value database storing default values required for setting values for each specification, and a template style database storing samples of various style specification information.

In another aspect of the invention, the style instructing unit indicates a list of samples registered in the sample database to a user depending on the elements of the structured document, causing the user to select a sample to be used to generate the style specification and to issue an instruction to change the contents of the sample, if necessary.

In a further embodiment of the present invention, an apparatus defines a style specification for outputting a structured document. The apparatus includes a style specification unit specifying the style specification for the structured document and generating a style sheet based on style specifications, and a sample database storing a sample specification specifying the style specification. The style specification unit obtains, from the sample database, contents of the sample specification selected by the style specification unit for each element and generates the style specification for each element corresponding to the instructed contents.

In yet a further embodiment of the present invention, there is provided a method of specifying a style specification visually outputting a structured document. The method includes functions like specifying the style specification for the structured document and generating a style sheet based on style specifications, storing a sample specification specifying the style specification, obtaining contents of the sample specification for each element, and generating the style specification for each element corresponding to the instructed contents.

These together with other objects and advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

FIG. 1 is an exemplary diagram illustrating a system structure of the present invention;

FIG. 2 is an exemplary diagram illustrating an instructed display image displayed by a style specification instruction unit in accordance with the present invention;

FIG. 3 is an exemplary diagram illustrating content of the template style registered in the template style database in accordance with the present invention;

FIG. 4 is an exemplary diagram illustrating the content of a macro registered in the macro database in accordance with the present invention;

FIG. 5 is an exemplary diagram illustrating the content of a default value registered in the default database in accordance with the present invention;

FIG. 6 is an exemplary diagram illustrating a changed display image by a style specification instructing unit in accordance with the present invention; and

FIG. 7 is an exemplary diagram illustrating a flow chart of the apparatus for supporting style specification of the present invention.

### DETAILED DESCRIPTION OF THE PREFERRED EMBODIMENT

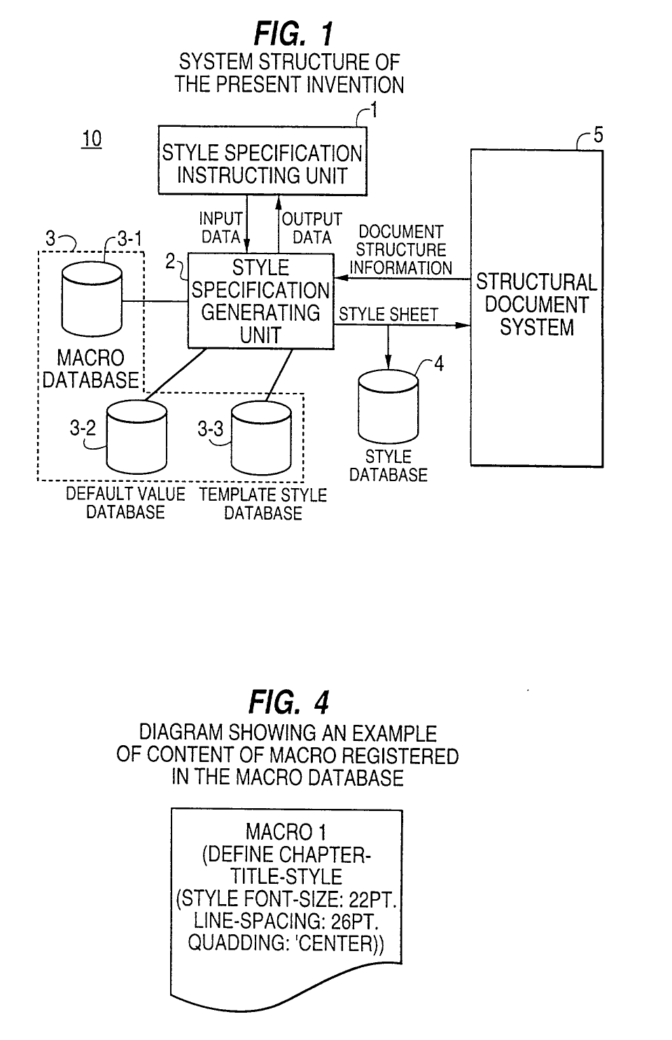

FIG. 1 is an exemplary diagram illustrating a system structure of the present invention. Referring to FIG. 1, apparatus 10 of the present invention includes, for example, a style specification instructing unit 1, a style specification generating unit 2, a database group (sample database) 3, including for example a macro database, a default value database and a template style database, storing various pieces of sample information and a style sheet database 4 storing generated style sheets. Apparatus 10 operates in conjunction with a structured document system 5, such as SGML.

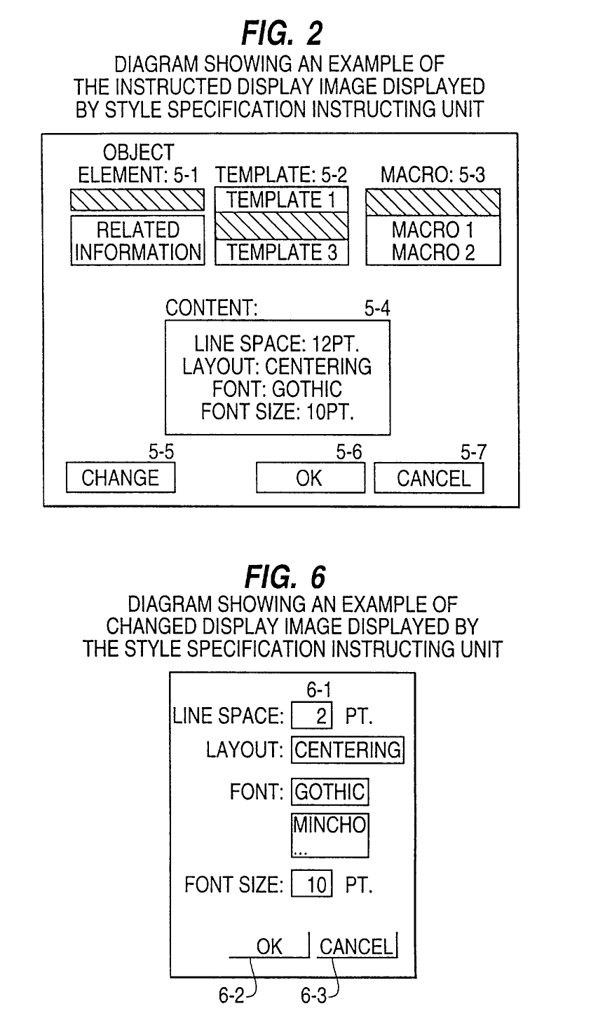

The style specification instructing unit 1 displays, for example, object element 5-1, a template 5-2, macros 5-3, and related information content 5-4 such as the layout, font and line spacing of the document, as illustrated in FIG. 2. In this regard, the style specification instructing unit 1 receives an instruction for style specification from a user, and then notifies the style specification generating unit 2 of the specified content.

The style specification generating unit 2 generates the style specification for each element in the content of the document based on the content notified by the style specification instructing unit 1. A style sheet corresponding to the document is generated, and the style sheet is stored in the style sheet database unit 4 or is sent directly to a system.

The database group unit (sample database) 3, storing a variety of sample information, includes a macro database 3-1, a default value database 3-2 and a template style database 3-3. The macro database 3-1 stores functions and macros used for style specification, the default value database 3-2 stores default values required for setting values for each specification, and the template style database 3-3 stores samples of the various style specification information template.

The structured document system 5 processes and administers structure and content of the documents, such as SGML. The structured document system 5 notifies the apparatus 10 of the elements of the document for style specification for supporting style specification. A discussion of the operation of structured document system 5 is omitted. However, structured document system 5 operates to process the structured documents in a typical fashion.

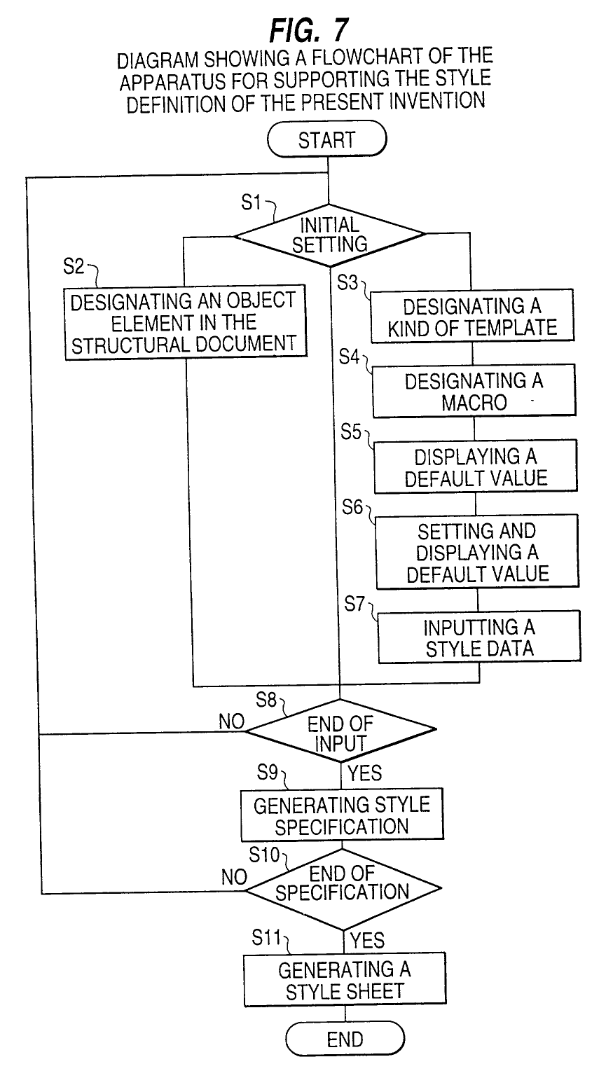

Operation of apparatus 10 will now be described in further detail with reference to FIGS. 1-7. Initially, the style specification instructing unit 1 displays the instructed display screen in step S1, as shown in FIG. 7. Object element 5-1, displayed on the screen shown in FIG. 2, acts as an input column for designating the element name of the document for style specification. Template 5-2, also displayed on the screen, acts as a column for displaying a list of templates registered in the template style sheet database 3-3 (illustrated in FIG. 1). Template style sheet 5-2 (illustrated in FIG. 1) enables a user to select a registered template and instruct the apparatus 10 in step S3. Macro 5-3 is the name of a column displayed on the screen and displays a list of macros registered in the macro database 3-1 (illustrated in FIG. 1). For example, the user selects a macro displayed on the screen, which in turn instructs the apparatus 10 in step S4. Similarly, content S-4 is a column displaying the content of the template style sheet or macro designated in step S3 (template designation) and S4 (macro designation), respectively. Additionally, change 5-5 is a column displayed on the screen, allowing a user to correct or change the content of the selected template or macro selected in steps S3 and S4, respectively.

In order to specify the style, object element 5-1 in the structure document and the template must be designated. The object element 5-1 and the template 5-2 may be selected in any order. In this example, however, the object element 5-1 is selected first. To designate the object element 5-1 in the structured document, a structured specification of the structured document is obtained. For example, in a SGML document system, a document type definition (DTD) is received by the apparatus 10 from a structured document system 5. Using the structured information, the elements defining the style are confirmed by the user selecting and instructing information displayed in the object element 5-1 column. This is accomplished by the user selecting object element 5-1 on a pull-down menu, whereby object element 5-1 information is displayed on the screen and selected by the user. The elements displayed in the object element 5-1 column may be designated by the user in a hierarchical structure, if preferred. For example, the title element in the document may be discriminated from the title element in the chapter. In this regard, the elements in the structured document are designated and displayed.

After selecting the object element 5-1, the template style is selected. A registered template name is retrieved from the template style database 3-3 (illustrated in FIG. 1), and is displayed on the template 5-2 column. The actual template to be used is determined when the user selects a template, which in turn instructs the apparatus 10. The designated template information is then stored as fixed data in the style specification instructing unit 1.

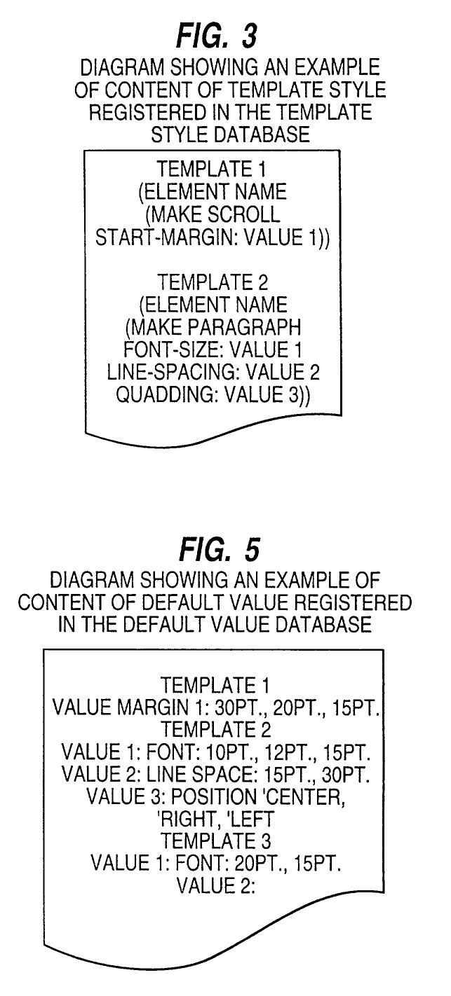

FIG. 3 is an exemplary diagram illustrating content of the template style registered in the template style database. More specifically, FIG. 3 illustrates a template stored in Document Style Semantics and Specification Language (DSSSL) . Setting items, such as object element names in the structured document and setting values to be set in each item, are defined in the template as variable names.

Similarly, when selecting macros, macro names are retrieved from the macro database 3-1 (illustrated in FIG. 1), and displayed on the macro 5-3 column in step S4. The user selects a macro from the macro 5-3 column, which in turn instructs apparatus 10 of the selected macro. The selected macro data is then stored as fixed data in the style specification instructing unit 1.

FIG. 4 is an exemplary diagram illustrating the content of a macro registered in the macro database when DSSSL is the designated style language. The displayed macro name may be selected and displayed in accordance with the previously selected object element 5-1 and template 5-2, if preferable. Alternatively, the object element 5-1 and template 5-2 to be applied in the structured document may be automatically determined by previously selecting the macros.

Once the template 5-2 is determined, the style specification instructing unit 1 transmits the instructed element name, template name and macro name to the style specification unit 2. The style specification generating unit 2 obtains a default value from the default value database 3-2 (illustrated in FIG. 1) corresponding to the template name in step S5 of FIG. 7. The default value corresponding to the variable names in the template 5-2 are set and displayed in content 5-4 column of the display screen in step S6. The default value database 3-2 is registered, for example, for each template, including the variable name and default value used in each template, as illustrated in FIG. 5.

FIG. 5 is an exemplary diagram illustrating the content of a default value registered in the default database.

A user confirms the specification information displayed in content 5-4 column of the displayed image. When the specification information is confirmed, style specification generating unit 2 is notified of the content of the specification currently displayed in content 5-4 column from style instructing unit 1. Confirmation occurs, for example, when a mouse is used to click the OK button 5-6. 6. Subsequently, the content is registered to the style sheet database 4 or structured document system 5 is notified via style specification generating unit 2.

If the user desires to change the content displayed, change button 5-5 may be selected using, for example, a mouse. Upon selecting the change button 5-5, a new image is displayed, as illustrated in FIG. 6.

FIG. 6 is an exemplary diagram illustrating a changed display image by a style specification instructing unit. In the newly displayed “changed” image, the contents of the setting items and default values stored in the default value database 3-2 are displayed ins step S6. The displayed setting items and default values are based on the selected template 5-2 or macro 5-3, and the default area becomes the input area. However, the default value may not always be displayed.

The value of the setting item displayed on the changed display may be edited by the user. For example, when registering a plurality of default values, corresponding to the items to be changed that are stored in default value database 3-2, the values may be displayed in the relevant column using the pull-down menu. In this regard, the values can be selected from the default value group.

Additionally, it is possible to instruct the apparatus 10 only to display specific changed items. That is, the user can specify which category of items are to be changed in step S7. In this regard, when the change button 5-5 is selected, only the categories specified by the user will be changed on the changed display. Alternatively, an additional button, such as a category button, may be placed next to change button 5-5. When the category button is clicked, previously sorted categories are displayed, and the categories selected by the user are instructed to change button 55. 5. Normally, the contents of the template 5-2 or macro 5-3 are all displayed. However, when specifying the categories using the category button, only the items corresponding to the selected categories are displayed. Hence, only the changed area is selected and displayed, allowing a user to easily confirm the change of the setting value.

After the value has been selected and changed, OK button 6-3 is clicked using a mouse indicating an end of input in step S8 of FIG. 7. At this time, style specification instructing unit 1 notifies style specification generating unit 2 of the changed style specification of the content corresponding to the designated elements. The style specification is generated in step S9 and is temporarily stored in the work area of the style specification generating unit 2, or in the work area of the memory device (not illustrated) , until instructed that the style specification for the document is completed in step S10. Hence, by utilizing the default values during the “change” procedure, the user effectively reduces the number of items for input. That is, the selected items will change to the default value, and the remaining items will be input by the user in step S9.

Additionally, the default values may be completely changed, or changed only in part. In this regard, a judging unit is provided to style specification instructing unit 1 or style specification generating unit 2. The values of the corresponding items are set in the input disable area, and the database corresponding to the registered setting items is notified not to be changed. Alternatively, a flag, indicating whether or not the setting items may be changed, is set in the default value database 3-2.

The style specification, generated according to the operation described above, uses contents which are registered in the macro database 3-1 and template style database 3-3, only after it is confirmed that there are no errors in the clause and notation of the contents. Hence, clauses containing errors are not generated, and validity of the style sheet (aggregated clauses) is assured.

Moreover, the newly defined style specification can be registered as the macro. That is, after a value is set, a new macro name is given to the column of the macro name 5-3 to newly register the macro name to the macro database 3-1, thereby allowing a user to select it.

The individual style specification groups, generated as explained above, are aggregated into one group in the style specification unit 2, forming a style sheet of the relevant documents in step S11. The style sheet is then stored in style sheet database 4 and transferred to the structured document system 5.

In above-mentioned embodiment of the present invention, the sample database is structured by the macro database, default value database and template style database. However, as the required sample is different depending on the regulation of the structured system, the database group (sample database) 3 is not limited to this structure. Additionally, database group 3 does not exist in an independent memory (or disk) area, and may be located in the style specification generating unit 2.

Further, style specification instructing unit 1 and style specification generating unit 2 may be individual application programs, only one application program or part of structured document system 5.

The present invention enables a user to easily define a style sheet for displaying or printing a document having a predetermined structure, even without a full understanding of the notation to define the style. Additionally, the validity of the style sheet can be checked automatically, improving the efficiency of generating the style sheet.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus defining a style specification for visually outputting a structured document in a structured document system, independently administering structured documents which include a predetermined number of structural elements and the style sheet which defines a format for visually outputting said structured document based on said style specification corresponding to said structured document when visually outputting said structured document, said apparatus comprising:
a style specification instructing means for instructing a definition of said style specification information;
a style specification generating means for generating a style specification based on the instruction from said style specification instructing means; and
a sample database for storing a sample defining the style specification and previously confirming validity of the style specification contents, wherein
said style specification instructing means indicates a list of samples registered in said sample database to a user depending on the elements of the structured document, causing the user to select a sample to be used to generate the style specification and to issue an instruction to change the contents of the sample, if necessary, and
said style specification generating means obtains, from the sample database, contents of the sample selected by said style specification instructing means for each element and generates the style specification for each element corresponding to the instructed contents to be changed.

2. A method of defining a style specification for visually outputting a structured document, said method comprising the steps of:
(a) storing a plurality of sample formats, defining various style specifications, in a style database;
(b) visually displaying said sample formats on a display screen at the instruction of an operator;
(c) selecting one sample format from said plurality of sample formats for each element of said structured document to be output; and
(d) modifying specification items in said selected sample format and defining the style specification.

3. A recording medium recording a computer readable program defining a style specification for visually outputting a structured document, said program comprising the steps of:
(a) storing a plurality of sample formats, defining various style specifications in a style database;
(b) visually displaying said sample formats on a display screen at the instruction of an operator;
(c) selecting one sample format from said plurality of sample format for each element of said structured document to be output; and
(d) modifying specification items in said selected sample format and defining the style specification.

4. An apparatus for defining a style specification for outputting a structured document, comprising:
a style specification instructing unit specifying the style specification for the structured document;
a style specification generating unit generating a style specification based on the style specification specified by the style specification instructing unit; and
a sample database storing a sample specification specifying the style specification, wherein
the style specification generating unit obtains, from the sample database, contents of the sample specification selected by the style specification instructing unit for each element and generates the style specification for each element corresponding to the instructed contents.

5. The apparatus of claim 4, wherein the sample database further comprises:
a macro database storing functions and macros used for style specification;
a default value database storing default values required for setting values for each specification; and
a template style database storing samples of various style specification information.

6. The apparatus of claim 4, wherein the style instructing unit indicates a list of samples registered in the sample database to a user depending on the elements of the structured document, causing the user to select a sample to be used to generate the style specification and to issue an instruction to change the contents of the sample, if necessary.

7. An apparatus for defining a style specification for outputting a structured document including a predetermined number of elements, comprising:
a style specification unit specifying the style specification for the structured document and generating a style specification based on the style specification; and
a sample database storing a sample specification specifying the style specification, wherein
the style specification unit obtains, from the sample database, contents of the sample specification selected by the style specification unit for each element and generates the style specification for each element corresponding to the instructed contents.

8. A method of specifying a style specification for visually outputting a structured document including a predetermined number of elements, the method comprising the steps of:
specifying the style specification for the structured document and generating a style specification based on the style specification;
storing a sample specification specifying the style specification;
obtaining contents of the sample specification for each element; and
generating the style specification for each element corresponding to the instructed contents.

9. An apparatus defining a style specification for visually outputting a structured document in a structured document system, independently administering structured documents which include a predetermined number of structural elements and the style sheet which defines a format for visually outputting said structured document based on said style specification corresponding to said structured document when visually outputting said structured document, said apparatus comprising:
a style specification instructing unit instructing a definition of said style specification information;
a style specification generating unit generating a style specification based on the instruction from said style specification instructing unit; and
a sample database storing a sample defining the style specification and previously confirming validity of the style specification contents, wherein
said style specification instructing unit indicates a list of samples registered in said sample database to a user depending on the elements of the structured document, causing the user to select a sample to be used to generate the style specification and to issue an instruction to change the contents of the sample, if necessary, and
said style specification generating unit obtains, from the sample database, contents of the sample selected by said style specification instructing unit for each element and generates the style specification for each element corresponding to the instructed contents to be changed.
